(19) United States
(12) Patent Application Publication
(10) Pub. No.: US 2025/0306057 A1
(43) Pub. Date: Oct. 2, 2025

(54) Physical Quantity Sensor And Inertial Measurement Unit

(71) Applicant: SEIKO EPSON CORPORATION, Tokyo (JP)

(72) Inventors: Yuichiro TSUYUKI, Matsumoto (JP); Yoshikazu EGUCHI, Fujimi (JP); Tomokazu KOBAYASHI, Shiojiri (JP)

(21) Appl. No.: 19/095,381

(22) Filed: Mar. 31, 2025

(30) Foreign Application Priority Data
Apr. 1, 2024 (JP) 2024-058743

(51) Int. Cl. G01P 15/125

(52) U.S. Cl. CPC G01P 15/125

(57) ABSTRACT

A physical quantity sensor 100 includes a support substrate 10 and a movable body 20 movably provided with respect to the support substrate 10, the movable body 20 includes a perforated region D1 having a through hole 26, a blank region D2 having no through hole 26, and a conductive film 27 provided in the blank region D2 on a lower surface 20f facing the support substrate 10, and the support substrate 10 includes a protrusion 15 overlapping the conductive film 27 in plan view.

The present application is based on, and claims priority from JP Application Serial Number 2024-058743, filed Apr. 1, 2024, the disclosure of which is hereby incorporated by reference herein in its entirety.

### BACKGROUND

### 1. Technical Field

The present disclosure relates to a physical quantity sensor and an inertial measurement unit including the physical quantity sensor.

### 2. Related Art

In recent years, the physical quantity sensors using a micro electro mechanical system (MEMS) technology have been developed. As such a physical quantity sensor, JP-A-2019-45167 describes a physical quantity sensor that detects acceleration in a Z-axis direction.

The physical quantity sensor described in JP-A-2019-45167 includes a substrate and a movable body swingably provided with respect to the substrate, and the substrate has a protrusion for coming into contact with the movable body to suppress further swinging when the movable body swings excessively.

The protrusion is not provided in a region in contact with an opening penetrating the movable body so that the movable body is not damaged. The opening is provided to reduce drag caused by air generated between the movable body and the substrate, in other words, damping caused by the viscosity of the gas.

JP-A-2019-45167 is an example of the related art.

In such a physical quantity sensor in the related art, when the movable body comes into contact with the protrusion, occurrence of sticking in which the movable body adheres to the protrusion is suppressed.

### SUMMARY

A physical quantity sensor according to an aspect of the present application includes a substrate, and a movable body movably provided with respect to the substrate, and the movable body includes, on a first surface facing the substrate, a first region having a through hole, a second region not having the through hole, and a first conductive film provided in the second region, and the substrate includes a protrusion overlapping the first conductive film in plan view.

An inertial measurement unit according to an aspect of the present application includes the above-described physical quantity sensor.

### BRIEF DESCRIPTION OF THE DRAWINGS

FIG. 1 is a plan view of a physical quantity sensor according to a first embodiment.

FIG. 2A is a cross-sectional view of the physical quantity sensor taken along line A-A in FIG. 1.

FIG. 2B is a cross-sectional view of the physical quantity sensor taken along line B-B in FIG. 1.

FIG. 3A is an enlarged cross-sectional view of a range III in FIG. 2A.

FIG. 3B is an enlarged cross-sectional view of a range III in FIG. 2A according to a modification of FIG. 3A.

FIG. 4 is an enlarged plan view of a range IV in FIG. 1 viewed from the lower surface of a movable body.

FIG. 5 is a flowchart for describing a manufacturing process of the physical quantity sensor.

FIG. 6 is a flowchart illustrating details of a silicon substrate preparation process S2 in FIG. 5.

FIG. 7 is a flowchart illustrating details of a movable body forming process S5 in FIG. 5.

FIG. 8A is a plan view illustrating an aspect in the manufacturing process.

FIG. 8B is a plan view illustrating an aspect in the manufacturing process according to the modification of FIG. 8A.

FIG. 9 is a cross-sectional view illustrating an aspect in the manufacturing process.

FIG. 10 is a cross-sectional view illustrating an aspect in the manufacturing process.

FIG. 11 is a cross-sectional view illustrating an aspect in the manufacturing process.

FIG. 12 is a cross-sectional view illustrating an aspect in the manufacturing process.

FIG. 13 is a cross-sectional view illustrating an aspect in the manufacturing process.

FIG. 14 is a cross-sectional view illustrating an aspect in the manufacturing process.

FIG. is an exploded perspective view illustrating a schematic configuration of an inertial measurement unit according to a second embodiment.

FIG. 16 is a perspective view of a substrate on which the physical quantity sensor is mounted.

### DESCRIPTION OF EMBODIMENTS

In the embodiments of the present disclosure, in some cases, components illustrated in the drawings are illustrated with different dimensional scales for ease of viewing.

In the drawings, in some cases, three axes of an X-axis, a Y-axis, and a Z-axis orthogonal to one another are illustrated. In the following description, in some cases, a tip side of an arrow of three axes is described as a “plus side”, and a base end side of the arrow is described as a “minus side”. In some cases, a direction parallel to the X-axis is referred to as an “X-axis direction”, a direction parallel to the Y-axis is referred to as a “Y-axis direction”, and a direction parallel to the Z-axis is referred to as a “Z-axis direction”. In some cases, viewing in the Z-axis direction is described as “plan view”.

In the following description, for example, with respect to a substrate, the description “on a substrate” represents any one of a case where one is disposed on the substrate and is in contact with the substrate, a case where one is disposed on the substrate via another structure, and a case where a part is disposed on the substrate and is in contact with the substrate and the other part is disposed on the substrate via another structure.

Assume that an upper surface of a certain configuration indicates a surface on a plus side of the configuration in the Z-axis direction, for example, an “upper surface of a movable body” indicates a surface on the plus side of the movable body in the Z-axis direction.

Assume that a lower surface of a certain configuration indicates a surface on a minus side of the configuration in the Z-axis direction, for example, a “lower surface of a movable body” indicates a surface on the minus side of the movable body in the Z-axis direction.

Assume that a surface of a certain configuration indicates a surface appearing outside the configuration.

### 1. First Embodiment

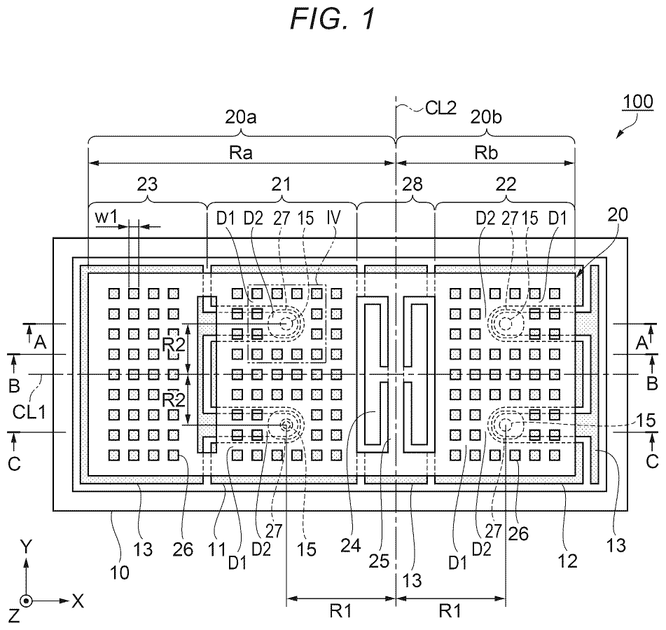

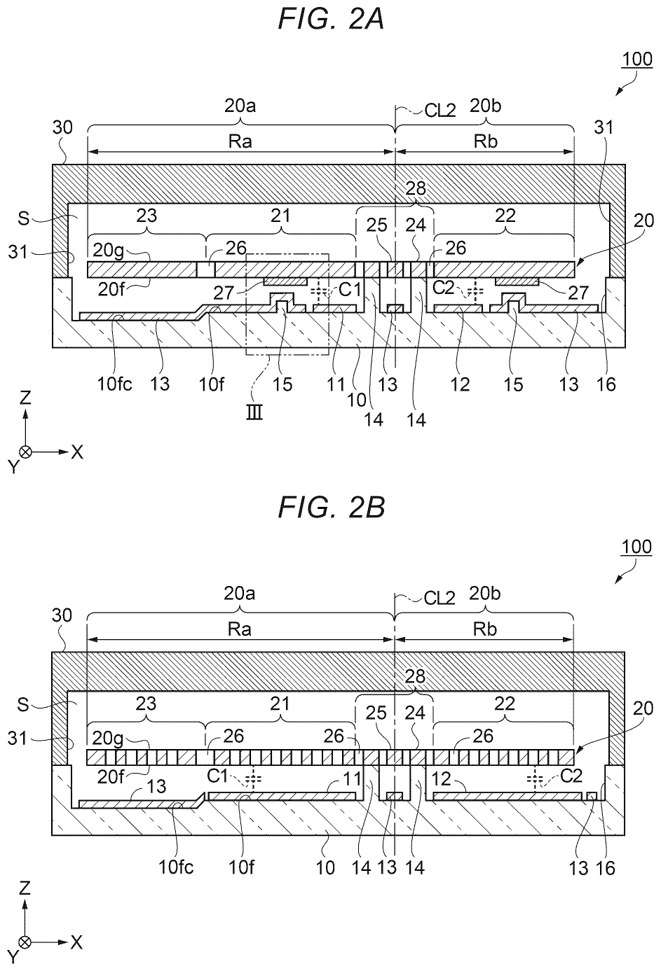

FIGS. 1, 2A, and 2B illustrate a schematic configuration of a physical quantity sensor 100 according to the present embodiment.

FIG. 1 is a plan view schematically illustrating the physical quantity sensor 100 according to a first embodiment, and for convenience of description, a lid body 30 is not illustrated. FIG. 2A is a cross-sectional view taken along line A-A in FIG. 1. FIG. 2B is a cross-sectional view taken along line B-B in FIG. 1.

The physical quantity sensor 100 of the present embodiment is a physical quantity sensor that detects a change in capacitance based on the displacement of a movable body 20, in other words, a change in physical quantity based on the displacement of the movable body 20. The physical quantity is, for example, acceleration.

In the present embodiment, the physical quantity sensor 100 is an acceleration sensor element that detects acceleration in the Z-axis direction, and specifically, is a capacitance-type Z-axis acceleration sensor element using MEMS technology.

The physical quantity sensor 100 includes a flat-plate-shaped movable body 20, a support substrate 10 that supports the movable body 20, and the lid body 30 bonded to the support substrate 10. In the present embodiment, the support substrate 10 is an example of a substrate.

### 1. 1. Configuration of Support Substrate

As illustrated in FIGS. 2A and 2B, the support substrate 10 includes a concave cavity 16.

The support substrate 10 is formed of a glass substrate made of borosilicate glass, which is an insulating material. The support substrate 10 may be formed of a silicon substrate or a ceramic substrate.

The support substrate 10 includes a first fixed electrode 11, a second fixed electrode 12, a dummy electrode 13, a column 14, and a protrusion 15 on an upper surface 10f in the cavity 16. The column 14 and the protrusion 15 are formed integrally with the support substrate 10.

The first fixed electrode 11 is provided on the minus side of the column 14 in the X-axis direction and overlaps a first mass region 21 of the movable body 20 in plan view.

The second fixed electrode 12 is provided on the plus side of the column 14 in the X-axis direction and overlaps a second mass region 22 of the movable body 20 in plan view.

The first fixed electrode 11 and the second fixed electrode 12 are detection electrodes that detect a change in the capacitance generated between the first fixed electrode 11 and the movable body 20 and between the second fixed electrode 12 and the movable body 20, respectively.

The dummy electrode 13 is provided on the minus side of the first fixed electrode 11 in the X-axis direction, on the plus side of the second fixed electrode 12 in the X-axis direction, and between the columns 14.

On the minus side of the column 14 in the X-axis direction, the dummy electrode 13 overlaps a third mass region 23 and the first mass region 21 of the movable body 20 in plan view, and a portion of the dummy electrode 13 overlapping the first mass region 21 covers the protrusion 15. On the plus side of the column 14 in the X-axis direction, the dummy electrode 13 overlaps the second mass region 22 of the movable body 20 in plan view, and a portion of the dummy electrode 13 overlapping the second mass region 22 covers the protrusion 15.

In the present embodiment, the dummy electrode 13 covering the protrusion 15 is an example of a second conductive film. Note that, as will be described later, the conductive film covering the protrusion 15 may be the first fixed electrode 11 or the second fixed electrode 12.

The dummy electrode 13 is insulated from the first fixed electrode 11 and the second fixed electrode 12.

The dummy electrode 13 is electrically coupled to the movable body 20. Therefore, the dummy electrode 13 has the same potential as the movable body 20, and substantially no electrostatic attractive force is generated therebetween. Therefore, the physical quantity sensor 100 of the present embodiment can effectively suppress the occurrence of the malfunction of the movable body 20 and the sticking in which the movable body 20 adheres to the protrusion 15.

The portion of the dummy electrode 13 overlapping the third mass region 23 of the movable body 20 is provided in a recessed portion 10fc of the upper surface 10f. The recessed portion 10fc is a portion recessed by one step in the upper surface 10f, and is a portion provided as clearance so as not to collide with the end portion of the movable body 20.

The column 14 supports the movable body 20 with a predetermined gap on the first fixed electrode 11 and the second fixed electrode 12.

The protrusion 15 is a stopper that restricts the movable body 20 from swinging with an excessive swing width, and prevents an end portion of the movable body 20 from colliding with the upper surface 10f of the support substrate 10.

The protrusion 15 protrudes from the upper surface 10f of the support substrate 10 to the plus side in the Z-axis direction and is provided to face the first mass region 21 and the second mass region 22 of the movable body 20.

As illustrated in FIG. 1, four protrusions 15 in total are provided at four positions, respectively, two positions overlapping the first mass region 21 of the movable body 20 and two positions overlapping the second mass region 22 of the movable body 20. The number of positions where the protrusions 15 are provided is not limited to four. The protrusions 15 may be provided at two, six, or eight or more positions.

Two protrusions 5 are provided along the extending direction of a beam portion 25 of the movable body 20. The beam portion 25 functions as a rotation shaft or a swing shaft of the movable body 20, and a center line CL2 overlaps the rotation shaft or the swing shaft of the movable body 20.

As described above, by providing a plurality of protrusions 15 along the extending direction of the beam portion 25 of the movable body 20, the physical quantity sensor 100 can disperse the impact when the movable body 20 and the protrusion 15 come into contact with each other.

The centers of the two protrusions 15 provided on a straight line parallel to the center line CL2 are provided at positions of a distance R2 that is line-symmetric with respect to a center line CL1 that bisects the movable body 20 in the Y-axis direction.

As described above, by disposing the plurality of protrusions 15 line-symmetrically with respect to the center line CL1, the physical quantity sensor 100 can prevent the posture of the movable body 20 from becoming unstable when the movable body 20 comes into contact with the protrusion 15.

The plurality of protrusions 15 is each provided at a position of distance R1 that is line-symmetric with respect to the center line CL2.

As described above, by disposing the plurality of protrusions 15 line-symmetrically with respect to the center line CL2, the physical quantity sensor 100 can make the maximum swing angle of the first mass region 21 of the movable body 20 and the maximum swing angle of the second mass region 22 of the movable body 20 the same. Therefore, it is possible to improve the accuracy of the physical quantity sensor 100. The swing angle can be referred to as a rotation angle.

The protrusion 15 is provided at a position not overlapping a perforated region D1 in which a through hole 26 of the movable body 20 is provided in plan view. In other words, the protrusion 15 is provided at a position overlapping a blank region D2 in which the through hole 26 of the movable body 20 is not provided in plan view.

Therefore, the movable body 20 comes into contact with the protrusion 15 in the blank region D2. Therefore, when the movable body 20 comes into contact with the protrusion 15, it is possible to suppress the occurrence of defects such as a fissure, a crack, and a chip starting from the edge of the through hole 26 in the movable body 20.

### 1. 2. Configuration of Lid Body

Similarly to the support substrate 10, the lid body 30 has a rectangular shape in plan view.

As illustrated in FIGS. 2A and 2B, the lid body 30 has a cavity 31 formed of a recessed portion on the lower surface side.

The lid body 30 is bonded to the peripheral edge of the support substrate 10 using a bonding material (not illustrated). The cavity 31 of the lid body 30 and the cavity 16 of the support substrate 10 form a storage space S. The movable body 20 is stored in the storage space S.

The lid body 30 has a communication hole (not illustrated). After the storage space S is brought into a desired atmosphere using the communication hole, the movable body 20 is sealed in the storage space S by closing the communication hole.

It is preferable that inert gas such as nitrogen, helium, or argon is sealed in the storage space S, and the storage space S substantially becomes an atmospheric pressure at a use temperature (about −40 degrees to 80 degrees). The storage space S is set to be the atmospheric pressure, so that viscous resistance increases, the damping effect is exerted, and the vibration of the movable body 20 can be promptly converged or stopped.

In the present embodiment, the lid body 30 is formed of a silicon substrate. The lid body 30 is not limited to the silicon substrate. The lid body 30 may be formed of, for example, a glass substrate or a ceramic substrate.

The lid body 30 is preferably coupled to the ground. As a result, a potential of the lid body 30 can be maintained to be constant, and thus, for example, a change in the capacitance between the lid body 30 and the movable body 20 can be reduced.

The separation distance between the lower surface of the lid body 30 and an upper surface 20g of the movable body 20 is, for example, preferably 15 μm or more, more preferably 20 μm or more, and still more preferably 25 μm or more. This configuration can sufficiently reduce the capacitance between the lid body 30 and the movable body 20, and has an effect of increasing the detection accuracy of the acceleration.

### 1. 3. Configuration of Movable Body

The movable body 20 is provided movably with respect to the support substrate 10. Specifically, the movable body 20 is swingably provided with respect to the support substrate 10 like a seesaw.

The movable body 20 is formed of a silicon substrate having conductivity. By using a silicon substrate having conductivity for the movable body 20, the movable body 20 can have a function as an electrode. Note that, using a non-conductive substrate for the movable body 20, a conductive electrode layer may be formed at a lower surface 20f of the movable body 20.

The movable body 20 includes a support portion 24, the beam portion 25 as a rotation shaft, the through hole 26, and a conductive film 27.

The support portion 24 is coupled to the column 14 of the support substrate 10.

The beam portion 25 is a rotation shaft or a swing shaft of the movable body 20. The beam portion 25 is supported by the support portion 24, has a portion extending from the support portion 24 in the Y-axis direction, and has a function as a torsion spring.

The movable body 20 is seesaw-swingably supported on the support substrate 10 with the beam portion 25 as a fulcrum.

The movable body 20 includes a first movable portion 20a and a second movable portion 20b.

The first movable portion 20a is a portion on the minus side in the X-axis direction from the center line CL2, and the second movable portion 20b is a portion on the plus side in the X-axis direction from the center line CL2.

The first movable portion 20a includes the first mass region 21, the third mass region 23, and a connection region 28.

The second movable portion 20b includes the second mass region 22 and the connection region 28.

Since the first movable portion 20a includes the third mass region 23, a distance Ra from the center line CL2 to the end portion of the first movable portion 20a is different from a distance Rb from the center line CL2 to the end portion of the second movable portion 20b. Therefore, the first movable portion 20a and the second movable portion 20b have mass different from each other.

Since the mass of the first movable portion 20a and the mass of the second movable portion 20b are different, the rotational force of the first movable portion 20a and the rotational force of the second movable portion 20b that occur when the acceleration in the Z-axis direction is applied to the movable body 20 are unbalanced. Therefore, when the acceleration in the Z-axis direction is applied to the physical quantity sensor 100, the movable body 20 tilts. The physical quantity sensor 100 outputs the tilt of the movable body 20 as changes in the capacitance C1 and C2 via the first fixed electrode 11 and the second fixed electrode 12.

The changes in the capacitance C1 and C2 are monitored by a circuit element 200 of a physical quantity sensor device 1 to be described later, and the physical quantity sensor device 1 outputs a detection signal of the acceleration in the Z-axis direction based on the changes in the capacitance C1 and C2.

The through hole 26 is a through hole penetrating the upper surface 20g and the lower surface 20f of the movable body 20 in the Z-axis direction. In the present embodiment, the lower surface 20f is an example of a first surface, and the upper surface 20g is an example of a second surface.

The through hole 26 is provided to reduce damping caused by the viscosity of the gas when the movable body 20 swings. The damping is a function of stopping the movement of the movable body 20, and can be referred to as flow resistance.

As described above, by providing the through hole 26 in the movable body 20, the physical quantity sensor 100 of the present embodiment can improve detection sensitivity of acceleration.

In the present embodiment, the through hole 26 is a square hole of which a planar shape is square. A length w1 of one side of the opening of the through hole 26 is preferably 5 μm to 20 μm, and is about 10 μm in the present embodiment. The length w1 corresponds to the inner diameter of the through hole 26.

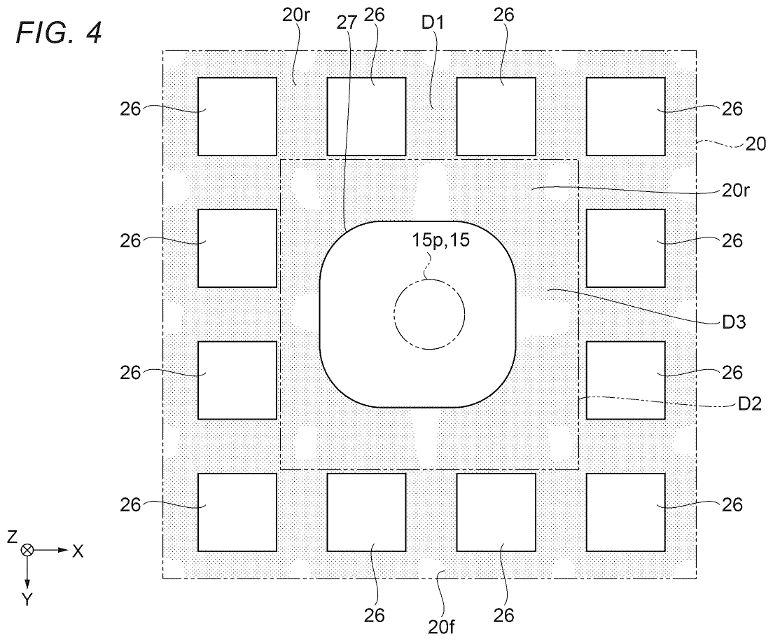

FIG. 4 is an enlarged plan view of the lower surface 20f of the movable body 20 when the range IV of FIG. 1 is viewed from the lower surface 20f side of the movable body 20. As illustrated in FIG. 4, the movable body 20 includes the perforated region D1 in which a plurality of through holes 26 is provided and the blank region D2 in which the through hole 26 is not provided. In FIG. 4, a two-dot chain line indicates the boundary between the blank region D2 and the perforated region D1, the inside of the region surrounded by the two-dot chain line is the blank region D2, and the outside of the region surrounded by the two-dot chain line is the perforated region D1. In the present embodiment, the perforated region D1 is an example of a first region, and the blank region D2 is an example of a second region.

The size of the blank region D2 is, for example, a size corresponding to a region in which 2×2 through holes 26 are provided in the perforated region D1. The size of the perforated region D1 may be larger or smaller than this size. The size of the perforated region D1 may be, for example, a size corresponding to a region in which 5×5 through holes 26 are provided in the perforated region D1.

The blank region D2 is surrounded by the perforated region D1. In other words, the blank region D2 is a region in which the through hole 26 is not provided in the perforated region D1. Therefore, in the through hole 26 facing the blank region D2 side in the perforated region D1, the interval between the adjacent through holes 26 is different between the blank region D2 side and the side opposite to the blank region D2 side. In the present embodiment, the plurality of through holes 26 is disposed at equal intervals in the perforated region D1. That is, the arrangement of the plurality of through holes 26 is different from that of the perforated region D1 at the boundary between the blank region D2 and the perforated region D1. Note that, the arrangement of at least some of the plurality of through holes 26 may be different in the perforated region D1. In addition, in the present embodiment, four sides of the blank region D2 are surrounded by the perforated region D1. However, in the present embodiment, at least three sides of the blank region D2 may be surrounded by the perforated region D1.

The blank region D2 is provided in a region corresponding to the protrusion 15 of the support substrate 10. As described above, in the movable body 20, by setting the region corresponding to the protrusion 15 as the blank region D2, even when the movable body 20 comes into contact with the protrusion 15, the movable body 20 comes into contact with the protrusion 15 in the blank region D2, and thus it is possible to suppress the occurrence of a defect such as a crack in the movable body 20.

In addition, in the present embodiment, the blank region D2 is provided at a position that is line-symmetric with respect to the center line CL1, and is provided at a position that is line-symmetric with respect to the center line CL2.

The conductive film 27 is provided at a position overlapping the protrusion 15 of the support substrate 10 in plan view in the blank region D2 of the lower surface 20f of the movable body 20. In other words, the protrusion 15 is provided so as to overlap the conductive film 27.

As described above, in the present embodiment, by providing the conductive film 27 and the protrusion 15 so as to overlap each other, the occurrence of sticking in which the movable body 20 adheres to the protrusion 15 is suppressed.

### 1. 4. Configuration for Suppressing Occurrence of Sticking

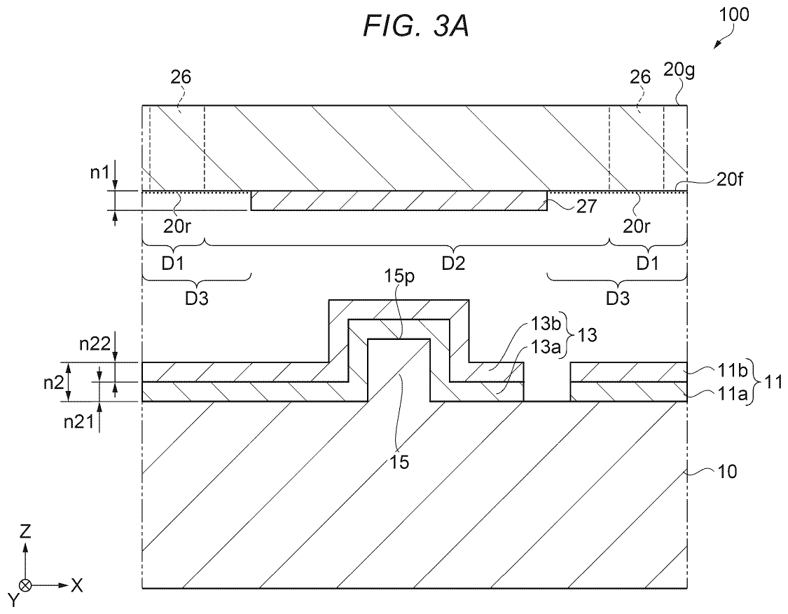

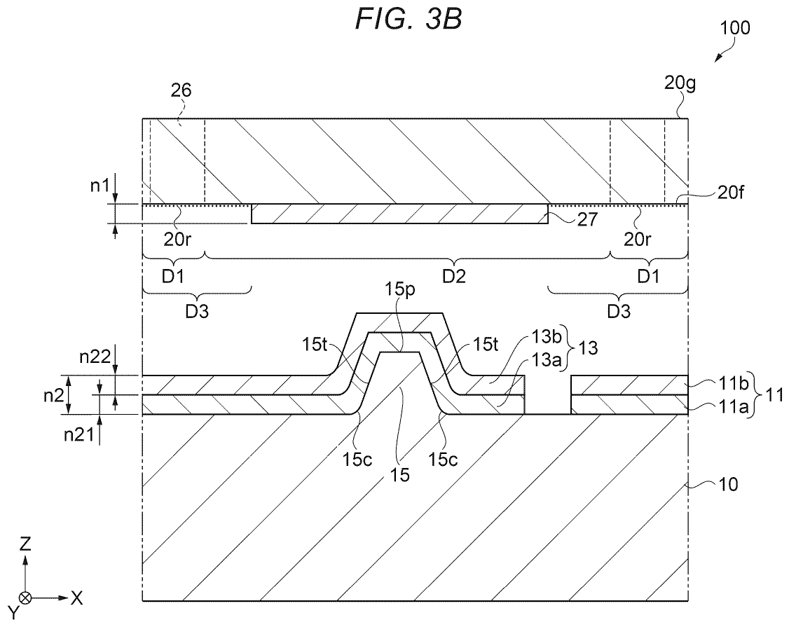

FIGS. 3A, 3B, and 4 are explanation diagrams illustrating a configuration for suppressing occurrence of sticking.

FIG. 3A is an enlarged cross-sectional view of a range III in FIG. 2A. FIG. 3B is an enlarged cross-sectional view of a range III in FIG. 2A according to a modification of FIG. 3A.

As illustrated in FIGS. 3A and 4, the shape of the protrusion 15 is preferably a cylinder having a circular top portion 15p. The shape of the protrusion 15 is not limited to a cylinder. For example, as illustrated in FIG. 3B, the shape may be a truncated cone having a circular top portion 15p.

The conductive film 27 is provided to face the protrusion 15.

In the present embodiment, the planar shape of the conductive film 27 is a rounded square with rounded four corners. The planar shape of the conductive film 27 is not limited to a rounded square.

The planar shape of the conductive film 27 is larger than the top portion 15p of the protrusion 15 in plan view.

In this way, by making the planar shape of the conductive film 27 larger than the protrusion 15, when the movable body 20 comes into contact with the protrusion 15, the conductive film 27 can always come into contact with the protrusion 15. Therefore, the physical quantity sensor 100 of the present embodiment can reliably suppress the occurrence of sticking in which the movable body 20 adheres to the protrusion 15.

Furthermore, the planar shape of the conductive film 27 is preferably as small as possible. For example, on the lower surface 20f of the movable body 20, the conductive film 27 may be provided only in a range in which contact with the protrusion 15 is assumed. A smaller planar shape of the conductive film 27 can suppress an increase in the weight of the movable body 20, and thus can suppress a decrease in the sensitivity of the physical quantity sensor 100.

The dummy electrode 13 is provided on the protrusion 15.

The dummy electrode 13 is a stacked film in which a plurality of conductive films is stacked. In the present embodiment, the dummy electrode 13 is a two-layer stacked film including a conductive film made of titanium (Ti) and a conductive film made of platinum (Pt). A first layer 13a is titanium and a second layer 13b is platinum. A thickness n21 of the first layer 13a is about 130 nm, and a thickness n22 of the second layer 13b is about 65 nm. Therefore, a thickness n2 of the dummy electrode 13 is about 195 nm.

The first fixed electrode 11 and the second fixed electrode 12 are formed in the same process as the dummy electrode 13 as described later. Therefore, the first fixed electrode 11 and the second fixed electrode 12 have the same layer structure as the dummy electrode 13. A first layer 11a of the first fixed electrode 11 is a conductive film made of titanium similarly to the first layer 13a of the dummy electrode 13, and a second layer 11b of the first fixed electrode 11 is a conductive film made of platinum similarly to the second layer 13b of the dummy electrode 13.

The conductive film 27 is made of platinum. In other words, the conductive film 27 is formed of the same material as the second layer 13b of the dummy electrode 13.

As described above, by forming the conductive film 27 with the same material as the second layer 13b of the dummy electrode 13, the work function difference from the second layer 13b of the dummy electrode 13 can be zero. Therefore, even when the conductive film 27 and the dummy electrode 13 come into contact with each other, occurrence of contact charging can be suppressed. Therefore, even when the movable body 20 comes into contact with the protrusion 15, it is possible to suppress the occurrence of sticking in which the movable body 20 adheres to the protrusion 15.

A thickness n1 of the conductive film 27 is 10 nm. In other words, the thickness n1 of the conductive film 27 is smaller than the thickness n2 of the dummy electrode 13.

Thus, by forming the conductive film 27 thinner than the dummy electrode 13, it is possible to suppress an increase in the weight of the movable body 20. Therefore, it is possible to suppress a decrease in sensitivity of the physical quantity sensor 100.

An etching damage 20r is formed on the lower surface 20f of the movable body 20. The etching damage 20r is a portion whose surface is roughened by etching when the through hole 26 is formed. The region where the etching damage 20r is formed is a damage region D3. In the present embodiment, the damage region D3 is an example of a third region.

On the lower surface 20f of the movable body 20, the etching damage 20r is not formed in the region where the conductive film 27 is formed. In other words, the damage region D3 and the conductive film 27 do not overlap each other in plan view. This is because the conductive film 27 is formed before the through hole 26 is formed, but has resistance to etching for forming the through hole 26, and thus functions as a protective film for protecting the lower surface 20f of the movable body 20 from etching.

Therefore, the surface of the conductive film 27 is smoother than the surface of the damage region D3. In other words, the surface roughness of the damage region D3 is larger than the surface roughness of the conductive film 27.

The surface roughness of the conductive film 27 can be quantified by Sku. Sku is called kurtosis (sharpness), and the larger the value of Sku, the more numerous and sharper the peaks and valleys on the surface, while a smaller value of Sku indicates a smoother and flatter surface.

Sku of the surface of the conductive film 27 is 4 to 6. On the other hand, when etching for forming the through hole 26 was performed without forming the conductive film 27 in a region facing the protrusion 15 of the lower surface 20f of the movable body 20, Sku of the region was 12 to 21.

In the present embodiment, by providing the conductive film 27, the incidence of sticking in which the movable body 20 adheres to the protrusion 15 could be significantly improved from the evaluation “Fair” when the conductive film 27 was not provided to the evaluation “Good” of the incidence of zero.

### 1. 5. Method of Manufacturing Physical Quantity Sensor

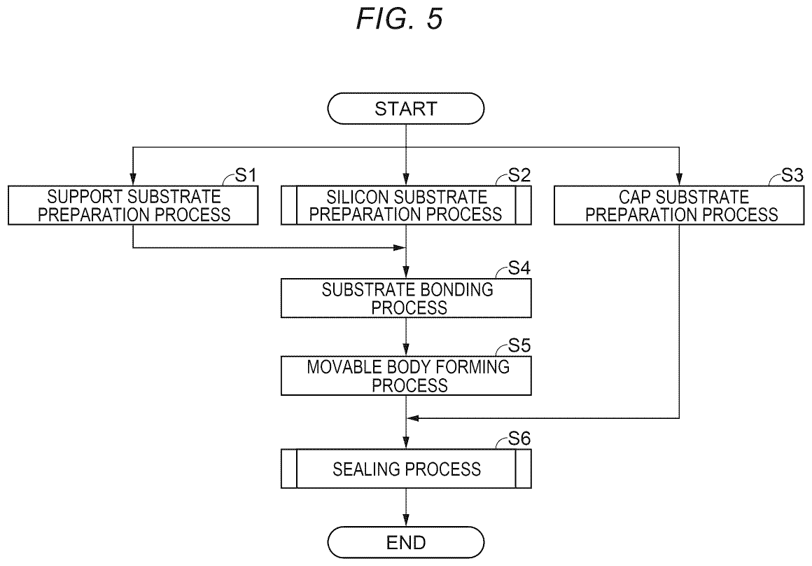

FIGS. 5 to 14 are explanation diagrams illustrating a method of manufacturing the physical quantity sensor 100.

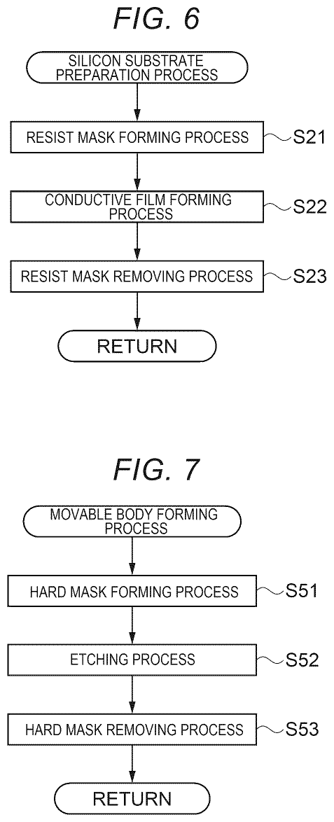

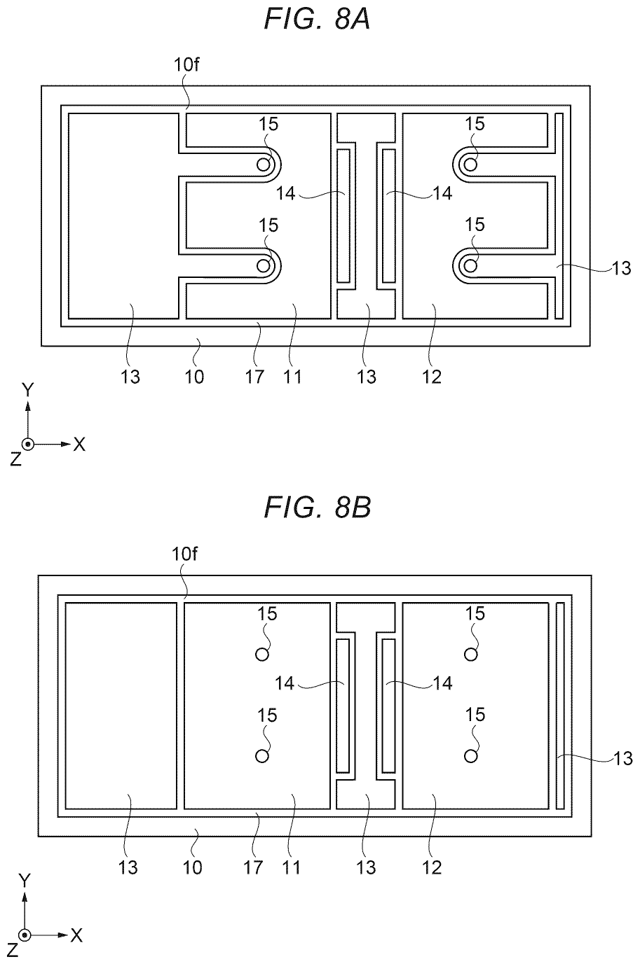

FIG. 5 is a flowchart for describing the manufacturing process of the physical quantity sensor 100. FIG. 6 is a flowchart illustrating details of a silicon substrate preparation process S2 of FIG. 5. FIG. 7 is a flowchart illustrating details of a movable body forming process S5 of FIG. 5. FIGS. 8A to 14 are cross-sectional views or plan views in each manufacturing process of the physical quantity sensor 100. The position of the cross section illustrated in each cross-sectional view is the position of line C-C in FIG. 1.

As illustrated in FIG. 5, the method of manufacturing the physical quantity sensor 100 includes a support substrate preparation process $1, the silicon substrate preparation process S2, a cap substrate preparation process S3, a substrate bonding process S4, the movable body forming process S5, and a sealing process S6.

In the support substrate preparation process S1, the support substrate 10 is formed from a glass substrate (not illustrated). In this process S1, first, an etching mask is formed at a glass substrate, and then the glass substrate is wet-etched to form the cavity 16, the column 14, and the protrusion 15, and then the first fixed electrode 11, the second fixed electrode 12, and the dummy electrode 13 made of a stacked film of titanium and platinum are formed at the upper surface 10f of the cavity 16 by using a lift-off method.

As illustrated in FIG. 8A, in the present embodiment, the electrode covering the protrusion 15 is the dummy electrode 13. However, as illustrated in FIG. 8B, the electrode covering the protrusion 15 may be the first fixed electrode 11 or the second fixed electrode 12.

When the shape of the protrusion 15 is a truncated cone as illustrated in FIG. 3B, in the support substrate preparation process S1, the columnar protrusion 15 is formed by etching using an etching mask, and then wet etching is performed without using the etching mask, so that the shape of the protrusion 15 can be a truncated cone. The protrusion 15 according to the modification illustrated in FIG. 3B has an inclined surface 15t of the protrusion 15 and a root portion 15c of a concave curved surface.

In the silicon substrate preparation process S2, the conductive film 27 is formed at a silicon substrate 20s using a lift-off method. As illustrated in FIG. 6, the silicon substrate preparation process S2 includes a resist mask forming process S21, a conductive film forming process S22, and a resist mask removing process S23.

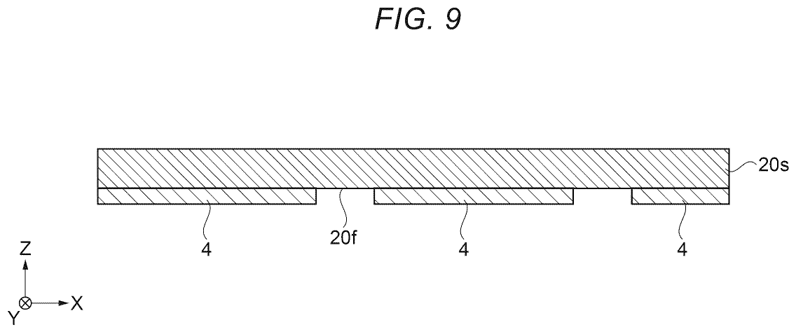

In the resist mask forming process S21, as illustrated in FIG. 9, a resist is applied to the lower surface 20f of the silicon substrate 20s and then patterned to form a resist mask 4.

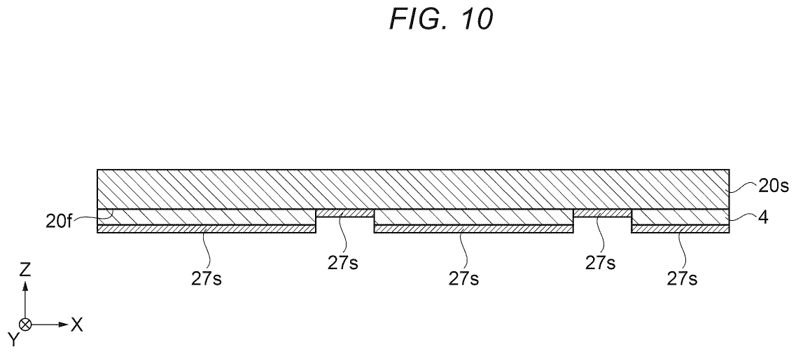

In the conductive film forming process S22, as illustrated in FIG. 10, a sputtered film 27s made of platinum is formed at the resist mask 4 and the lower surface 20f of the silicon substrate 20s by a sputtering method.

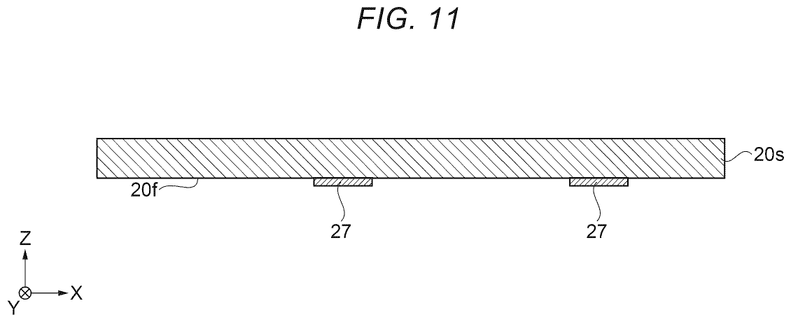

In the resist mask removing process S23, as illustrated in FIG. 11, the resist mask 4 is removed, and a patterned conductive film 27 is formed at the lower surface 20f of the silicon substrate 20s.

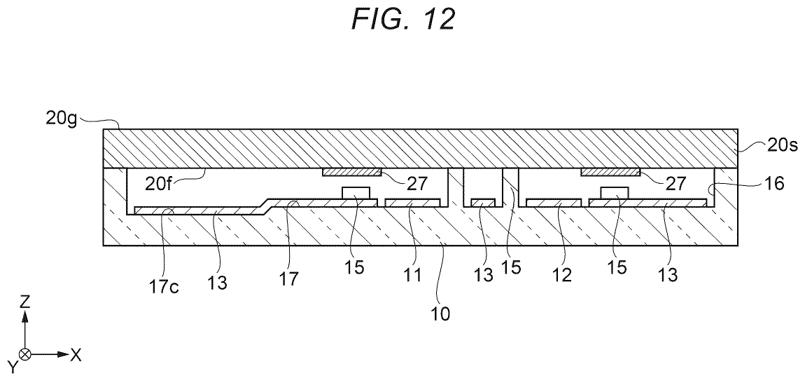

In the substrate bonding process S4, as illustrated in FIG. 12, the support substrate 10 formed in the support substrate preparation process S1 and the silicon substrate 20s formed in the silicon substrate preparation process S2 are bonded. For example, anodic bonding can be used for bonding the support substrate 10 and the silicon substrate 20s.

In the movable body forming process S5, the movable body 20 is formed from the silicon substrate 20s. As illustrated in FIG. 7, the movable body forming process S5 includes a hard mask forming process S51, an etching process S52, and a hard mask removing process S53.

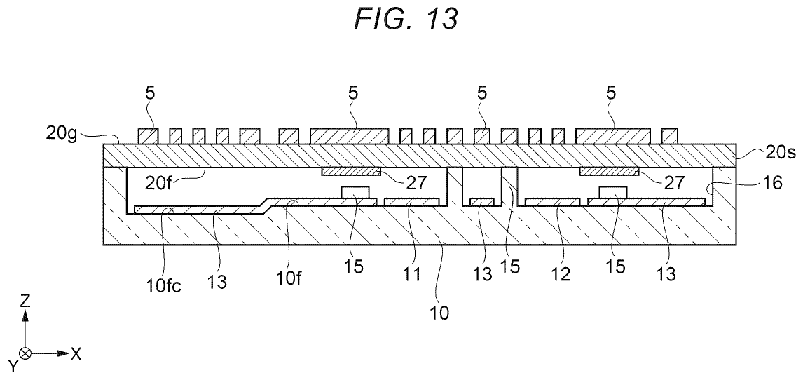

In the hard mask forming process S51, a hard mask 5 is formed after the silicon substrate 20s is thinned. In this process S51, first, as illustrated in FIG. 13, the silicon substrate 20s is thinned using a grinder and a polisher, and then silicon oxide (SiO₂) is deposited on the upper surface 20g of the thinned silicon substrate 20s. Thereafter, the patterning is performed to form the hard mask 5.

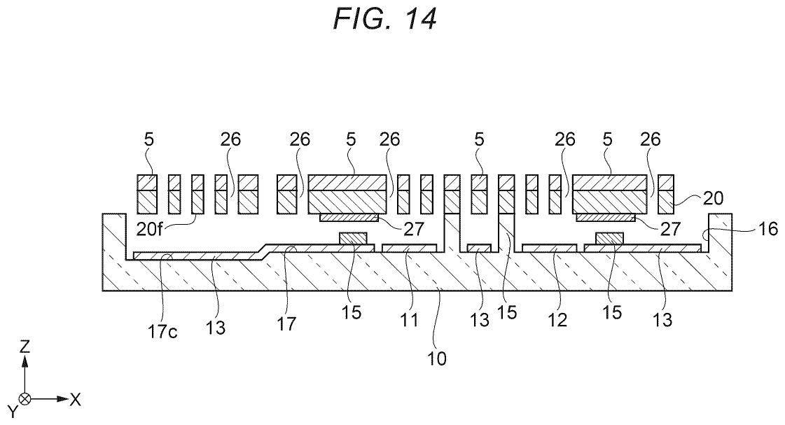

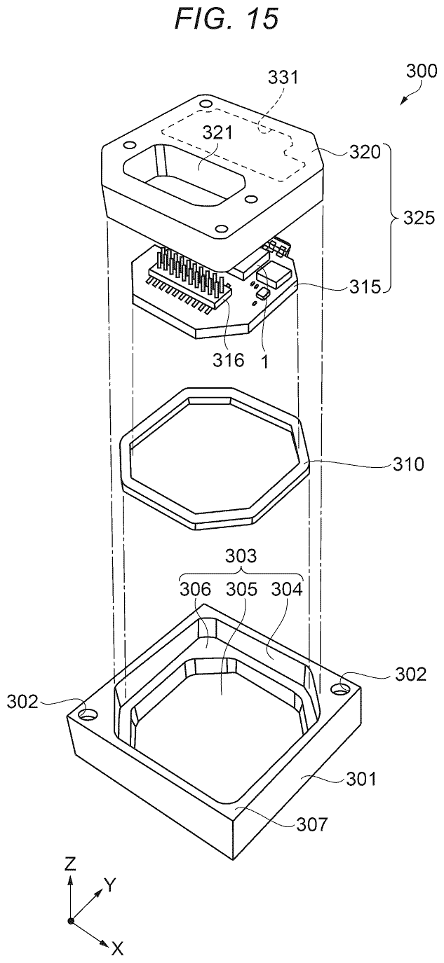

In the etching process S52, the silicon substrate 20s is dry-etched using the hard mask 5 to form the movable body 20 having the support portion 24, the beam portion 25, and the through hole 26 as illustrated in FIG. 14. As illustrated in FIG. 4, the etching damage 20r is formed on the lower surface 20f of the movable body 20 by the dry etching in the process S52.

Thus, in the etching process S52, the upper surface 20g of the movable body 20 is protected by the hard mask 5. Therefore, the etching damage 20r due to dry etching is not formed on the upper surface 20g of the movable body 20. Therefore, the surface roughness of the lower surface 20f of the movable body 20 on which the etching damage 20r is formed is larger than the surface roughness of the upper surface 20g of the movable body 20 on which the etching damage 20r is not formed.

In the hard mask removing process S53, the hard mask 5 on the upper surface 20g of the movable body 20 is removed.

In the cap substrate preparation process S3, the lid body 30 having the cavity 31 is formed from a silicon substrate (not illustrated).

In the sealing process S6, the lid body 30 formed in the cap substrate preparation process S3 is bonded to the support substrate 10, and the movable body 20 is sealed in the storage space S between the lid body 30 and the support substrate 10. For example, glass frit bonding can be used for bonding the lid body 30 and the support substrate 10.

As described above, the physical quantity sensor 100 is obtained.

As described above, the physical quantity sensor 100 of the present embodiment includes the support substrate 10 as a substrate and the movable body 20 movably provided with respect to the support substrate 10, the movable body 20 includes, on the lower surface 20f as the first surface facing the support substrate 10, the perforated region D1 as the first region having the through hole 26, the blank region D2 as the second region not having the through hole 26, and the conductive film 27 as the first conductive film provided in the blank region D2, and the support substrate 10 includes the protrusion 15 overlapping the conductive film 27 in plan view.

As described above, the movable body 20 includes the conductive film 27 in the blank region D2, and the support substrate 10 includes the protrusion 15 overlapping the conductive film 27 in plan view. Therefore, even when the movable body 20 comes into contact with the protrusion 15 due to excessive swinging, it is possible to suppress the occurrence of sticking in which the movable body 20 adheres to the protrusion 15.

In the physical quantity sensor 100 of the present embodiment, the conductive film 27 as the first conductive film is a noble metal.

As described above, since the conductive film 27 is a noble metal, the conductive film 27 is prevented from being damaged by etching for forming the through hole 26 in the movable body 20, and the surface of the conductive film 27 is maintained in a smooth state. Therefore, even when the movable body 20 comes into contact with the protrusion 15 due to excessive swinging, it is possible to suppress the occurrence of sticking in which the movable body 20 adheres to the protrusion 15.

In the physical quantity sensor 100 of the present embodiment, the support substrate 10 includes the dummy electrode 13 as the second conductive film covering the protrusion 15, and the material of the conductive film 27 as the first conductive film and the material of the dummy electrode 13 are the same.

Therefore, since the work function difference between the conductive film 27, the movable body 20, and the dummy electrode 13 can be zero, even when the conductive film 27 and the dummy electrode 13 come into contact with each other, the occurrence of contact charging is suppressed. Therefore, even when the movable body 20 excessively swings and comes into contact with the protrusion 15, it is possible to suppress the occurrence of sticking in which the movable body 20 adheres to the protrusion 15.

In the physical quantity sensor 100 of the present embodiment, the film thickness of the conductive film 27 as the first conductive film is thinner than the film thickness of the dummy electrode 13 as the second conductive film.

As described above, since the film thickness of the conductive film 27 is smaller than the film thickness of the dummy electrode 13, the weight increase of the movable body 20 due to the conductive film 27 can be suppressed to be small. Therefore, in the physical quantity sensor 100 of the present embodiment, it is possible to suppress the decrease in the sensitivity of the physical quantity sensor 100 while suppressing the occurrence of sticking in which the movable body 20 adheres to the protrusion 15.

In the physical quantity sensor 100 of the present embodiment, the conductive film 27 as the first conductive film is larger than the protrusion 15 in plan view.

Therefore, even when the movable body 20 excessively swings, the movable body 20 comes into contact with the protrusion 15 via the conductive film 27. Therefore, it is possible to suppress the occurrence of sticking in which the movable body 20 adheres to the protrusion 15.

In the physical quantity sensor 100 of the present embodiment, the surface roughness of the damage region D3 as the third region in which the conductive film 27 as the first conductive film is not provided on the lower surface 20f of the movable body 20 as the first surface is larger than the surface roughness of the conductive film 27.

Thus, the surface roughness of the damage region D3 is larger than the surface roughness of the conductive film 27. Therefore, even when the movable body 20 excessively swings and comes into contact with the protrusion 15, it is possible to suppress the occurrence of sticking in which the movable body 20 adheres to the protrusion 15.

In the physical quantity sensor 100 of the present embodiment, the surface roughness of the lower surface 20f of the movable body 20 as the first surface is larger than the surface roughness of the upper surface 20g of the movable body 20 as the second surface opposite to the lower surface 20f of the movable body 20.

Thus, the lower surface 20f of the movable body 20 has a large surface roughness. Therefore, by providing the conductive film 27 on the lower surface 20f of the movable body 20, the movable body 20 comes into contact with the protrusion 15 via the conductive film 27, so that it is possible to suppress the occurrence of sticking in which the movable body 20 adheres to the protrusion 15.

### 2. Second Embodiment

### 2. 1. Overview of Inertial Measurement Unit

FIG. 15 is an explanation diagrams of a sensor module 300 as an inertial measurement unit (IMU) including the physical quantity sensor 100.

FIG. 15 is an exploded perspective view illustrating a schematic configuration of the sensor module 300.

The sensor module 300 is mounted on a device to be mounted such as an automatic vehicle, a robot, a smartphone, or a portable activity meter, and is used as a device that detects a posture, a behavior, or the like of the device to be mounted.

As illustrated in FIG. 15, the sensor module 300 includes an outer case 301, a bonding member 310, and a sensor unit 325, and has a configuration in which the sensor unit 325 is fitted or inserted into an inner portion 303 of the outer case 301 with the bonding member 310 interposed therebetween.

The outer case 301 is a box-shaped container having a rectangular parallelepiped outer shape and no lid, and the inner portion 303 thereof is an internal space surrounded by a wall surface 304, a bottom surface 305, and a bonding surface 306. A material of the outer case 301 is, for example, aluminum. The material of the outer case 301 may be another metal such as zinc or stainless steel, a resin, or a composite material of the metal and the resin.

The outer shape of the outer case 301 is a rectangular parallelepiped having a substantially square planar shape, and through holes 302 are formed in the vicinity of two vertices located in the diagonal direction of the square. The sensor module 300 is attached to the device to be mounted by screwing or the like using the through hole 302.

The sensor unit 325 includes an inner case 320 and a substrate 315.

The physical quantity sensor device 1 in which the physical quantity sensor 100 is incorporated, a connector 316 for external connection, and the like are mounted on the substrate 315.

The inner case 320 supports the substrate 315 and is housed in the inner portion 303 of the outer case 301. The thickness of the inner case 320, in other words, the height in the Z-axis direction is equal to or lower than the height from an upper surface 307 of the outer case 301 to the bonding surface 306. A material similar to the material of the outer case 301 may be used for that of the inner case 320.

A recessed portion 331 for preventing contact with the physical quantity sensor device 1 and an opening 321 for exposing the connector 316 are formed on the lower surface of the inner case 320.

### 2. 2. Overview of Substrate

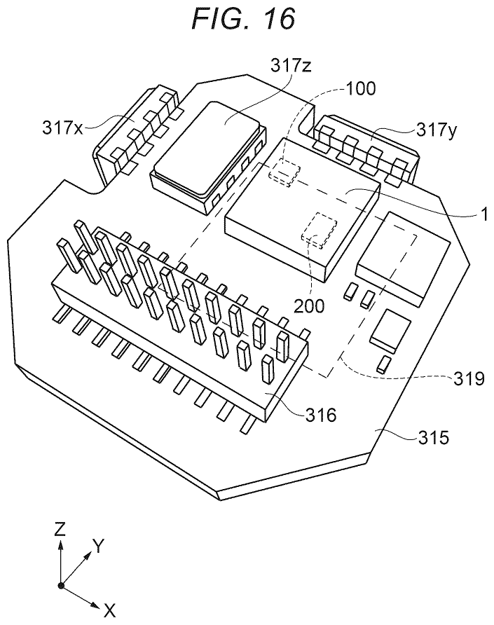

FIG. 16 is a perspective view of the substrate 315 on which the physical quantity sensor 100 is mounted.

As illustrated in FIG. 16, the physical quantity sensor device 1, the connector 316, angular velocity sensors 317x, 317y, and 317z, and the like are mounted on the upper surface and the side surface of the substrate 315. A control IC 319 is mounted on the lower surface of the substrate 315.

The substrate 315 is a multilayer substrate in which a plurality of through holes is formed. The substrate 315 is a glass epoxy substrate. A rigid substrate such as a composite substrate or a ceramic substrate may be used for the substrate 315.

The physical quantity sensor device 1 includes the physical quantity sensor 100, the circuit element 200, and a package on which the physical quantity sensor 100 and the circuit element 200 are mounted.

The circuit element 200 includes a detection circuit that detects acceleration in the Z-axis direction based on a signal from the physical quantity sensor 100, an output circuit that converts a signal from the detection circuit into a predetermined detection signal and outputs the detection signal, and the like.

The connector 316 is a plug-type connector and includes two rows of connection terminals disposed at equal pitches in the X-axis direction. In the present embodiment, there are 10 pins of connection terminals in one row, and the connector 316 includes two rows, that is, 20 pins in total. However, the number of connection terminals may be changed as appropriate depending on design specifications.

The angular velocity sensor 317z is a gyro sensor that detects an angular velocity of one axis in the Z-axis direction. The angular velocity sensor 317z is preferably a vibration gyro sensor that uses quartz crystal as a vibrator and detects an angular velocity from a Coriolis force applied to a vibrating object. The vibrator is not limited to quartz crystal, and ceramic or silicon may be used.

The angular velocity sensor 317x that detects an angular velocity of one axis in the X-axis direction is mounted on the side surface of the substrate 315 in the X-axis direction such that a mounting surface is orthogonal to the X axis. Similarly, the angular velocity sensor 317y that detects an angular velocity of one axis in the Y-axis direction is mounted on the side surface of the substrate 315 in the Y-axis direction such that the mounting surface is orthogonal to the Y axis.

The angular velocity sensors 317x, 317y, and 317z are not limited to the configuration using one angular velocity sensor for each axis, three sensors in total, and any sensor that can detect the angular velocities of three axes may be used. For example, a sensor device that can detect the angular velocities of three axes in one device or package may be used.

The physical quantity sensor device 1 is an acceleration sensor for measuring acceleration in the Z-axis direction, but may measure acceleration in the X-axis direction or the Y-axis direction.

On the physical quantity sensor device 1, the physical quantity sensor 100 that measures acceleration in the X-axis direction and/or the Y-axis direction may be mounted to detect acceleration in the Z-axis direction and the Y-axis direction, acceleration in the Z-axis direction and the X-axis direction, or acceleration in three axial directions of X, Y, and Z.

The control IC 319 is a micro controller unit (MCU), incorporates a storage unit including a nonvolatile memory, an arithmetic circuit that performs temperature correction processing, and the like, and is a control unit that controls each unit of the sensor module 300.

The storage unit stores a program in which an order and contents for detecting the acceleration and the angular velocity are defined, a program which digitalizes a detection signal to be incorporated into packet data, accompanying data, and the like. In addition, a plurality of electronic components such as a temperature sensor is mounted on the substrate 315.

According to such a sensor module 300, since the physical quantity sensor device 1 on which the physical quantity sensor 100 is mounted is used, it is possible to provide the sensor module 300 having excellent impact resistance and improved reliability.

As described above, according to the sensor module 300 as the inertial measurement unit including the physical quantity sensor 100 of the present embodiment, it is possible to provide the inertial measurement unit having high reliability in addition to the effects of the first embodiment.

Although preferred embodiments have been described above, the present disclosure is not limited to the above-described embodiments. The configuration of each unit of the present disclosure can be replaced with any configuration that exhibits the function similar to that of the above-described embodiments.

What is claimed is:

1. A physical quantity sensor comprising:
a substrate; and
a movable body movably provided with respect to the substrate, wherein
the movable body includes: on a first surface facing the substrate, a first region having a through hole; a second region not having the through hole; and a first conductive film provided in the second region, and
the substrate includes a protrusion overlapping the first conductive film in plan view.

2. The physical quantity sensor according to claim 1, wherein
the first conductive film is a noble metal.

3. The physical quantity sensor according to claim 1, wherein
the substrate includes a second conductive film covering the protrusion, and
a material of the first conductive film and a material of the second conductive film are same.

4. The physical quantity sensor according to claim 3, wherein
a film thickness of the first conductive film is smaller than a film thickness of the second conductive film.

5. The physical quantity sensor according to claim 1, wherein
the first conductive film is larger than the protrusion in plan view.

6. The physical quantity sensor according to claim 1, wherein
a surface roughness of a third region of the first surface where the first conductive film is not provided is larger than a surface roughness of the first conductive film.

7. The physical quantity sensor according to claim 1, wherein
a surface roughness of the first surface is larger than a surface roughness of a second surface opposite to the first surface.

8. An inertial measurement unit comprising a physical quantity sensor according to claim 1.
